(19) United States
(12) Patent Application Publication
(10) Pub. No.: US 2025/0140942 A1
(43) Pub. Date: May 1, 2025

(54) METHOD FOR MANUFACTURING BATTERY

(71) Applicant: TOYOTA JIDOSHA KABUSHIKI KAISHA, Toyota-shi (JP)

(72) Inventors: Yosuke SHIMURA, Nagakute-shi (JP); Takahiko NAKANO, Nagoya-shi (JP); Hirokazu TAKEUCHI, Toyota-shi (JP); Masato NODA, Toyota-shi (JP); Atsushi SUGIHARA, Toyota-shi (JP); Jun IZUMI, Toyota-shi (JP); Yuka YOKOI, Nagoya-shi (JP)

(21) Appl. No.: 18/929,649

(22) Filed: Oct. 29, 2024

(30) Foreign Application Priority Data
Oct. 31, 2023 (JP) 2023-187165

(51) Int. Cl. H01M 10/42; H01M 50/609

(52) U.S. Cl. CPC H01M 10/4235; H01M 50/609

(57) ABSTRACT

A method for manufacturing a battery, the method including: a first step of preparing an electrode body including a substance that is capable of retaining an electrolytic solution and an electrolytic solution that is retained at the substance; a second step of accommodating the electrode body in an exterior body; and a third step of supplying an electrolytic solution to an interior of the exterior body.

### CROSS-REFERENCE TO RELATED APPLICATION

This application is based on and claims priority under 35 USC 119 from Japanese Patent Application No. 2023-187165, filed on Oct. 31, 2023, the disclosure of which is incorporated by reference herein.

### BACKGROUND

### Technical Field

The present disclosure relates to a method for manufacturing a battery.

### Related Art

In a process for manufacturing a battery using an electrolytic solution obtained by dissolving an electrolyte in an organic solvent, a liquid injection operation is performed in which the electrolytic solution is supplied to an interior of an exterior body that accommodates an electrode body, and the electrolytic solution is caused to penetrate into the electrode body.

In some cases, processing is carried out in which an electrode of the battery is pressed at a high pressure to increase an energy density. When a packing density of an electrode active material within the electrode is increased by pressing the electrode, a penetrability of the electrolytic solution decreases. The decrease in the penetrability of the electrolytic solution causes a decrease in efficiency of the liquid injection operation.

Japanese Patent Application Laid-Open (JP-A) No. 2003-077545 discloses a method for manufacturing a battery in which an electrode body, having a polymer layer disposed between an electrode and a separator, is accommodated in a battery case, and then an electrolytic solution is injected into the battery case to cause the electrolytic solution to penetrate into the electrode body.

The method described in JP-A No. 2003-077545 improves the operability as compared with a case of preparing an electrode body using a polymer layer that has been impregnated with an electrolytic solution in advance. On the other hand, reduction in the time required for penetration of the electrolytic solution into the electrode body is desired.

### SUMMARY

In view of the foregoing, an object of an exemplary embodiment of the present disclosure is to provide a method for manufacturing a battery in which a time required for penetration of an electrolytic solution into an electrode body is reduced.

The means for solving the above-described problem include the following exemplary embodiments.

<1> A method for manufacturing a battery, the method including:
a first step of preparing an electrode body including a substance that is capable of retaining an electrolytic solution and an electrolytic solution that is retained at the substance;
a second step of accommodating the electrode body in an exterior body; and
a third step of supplying an electrolytic solution to an interior of the exterior body.

<2> The method for manufacturing a battery according to <1>, wherein the substance that is capable of retaining an electrolytic solution is a polymer.

<3> The method for manufacturing a battery according to <1> or <2>, wherein the substance that is capable of retaining an electrolytic solution and the electrolytic solution are in a gel state.

<4> The method for manufacturing a battery according to any one of <1> to <3>, wherein a method for preparing the electrode body in the first step is a method of contacting the electrolytic solution with at least one of an electrode or a separator that includes the substance that is capable of retaining an electrolytic solution, and subsequently preparing the electrode body using the at least one of the electrode or the separator that has been contacted with the electrolytic solution.

<5> The method for manufacturing a battery according to any one of <1> to <3>, wherein a method for preparing the electrode body in the first step is a method of preparing the electrode body using at least one of an electrode or a separator that includes the substance that is capable of retaining an electrolytic solution, and subsequently contacting the electrolytic solution with the electrode body.

### BRIEF DESCRIPTION OF THE DRAWINGS

Exemplary embodiments of the present disclosure will be described in detail based on the following figures, wherein:

FIG. 1 is a diagram schematically illustrating an example of a configuration of a laminated body included in an electrode body;

FIG. 2 is a diagram schematically illustrating an example of application of a battery module to an electric vehicle;

FIG. 3 is a diagram schematically illustrating an example of a configuration of a battery module;

FIG. 4 is a diagram schematically illustrating an example of a configuration of a battery module; and

FIG. 5 is a diagram schematically illustrating an example of a configuration of a battery cell included in a battery module.

### DETAILED DESCRIPTION

In the present disclosure, a numerical range indicated by using “to” means a range in which numerical values described before and after “to” are included as a minimum value and a maximum value, respectively.

In numerical ranges described in the present disclosure in a stepwise manner, an upper limit value or a lower limit value described in a certain numerical range may be replaced with an upper limit value or a lower limit value of another numerical range described in a stepwise manner. In the numerical ranges described in the present disclosure, an upper limit value or a lower limit value described in a certain numerical range may be replaced with a value indicated in the examples.

In the present disclosure, the term “step” includes not only independent steps, and even in a case in which a step cannot be clearly distinguished from another step, it is encompassed by this term as long as the intended purpose of the step is achieved.

In a case in which an exemplary embodiment is explained in the present disclosure with reference to the drawings, the configuration of the exemplary embodiment is not limited to the configuration illustrated in the drawings. Furthermore, sizes of members in the respective drawings are conceptual, and relative relationships between sizes of members are not limited thereto.

A method for manufacturing a battery of the present disclosure includes:
a first step of preparing an electrode body including a substance that is capable of retaining an electrolytic solution and an electrolytic solution that is retained at the substance;
a second step of accommodating the electrode body in an exterior body; and
a third step of supplying the electrolytic solution to an interior of the exterior body.

In a general method for manufacturing a battery, an electrode body is accommodated in an exterior body, and then an electrolytic solution is supplied to an interior of the exterior body. Then, the operation is stopped and put on hold until the electrolytic solution that has been supplied to the exterior body penetrates into the electrode body. This on-hold time can cause a decrease in efficiency of the liquid injection operation.

In the method of the present disclosure, the electrolytic solution is retained at a substance that is capable of retaining an electrolytic solution, prior to accommodating the electrode body in the exterior body. In other words, a portion of a total amount of the electrolytic solution used for the impregnation of the electrode body is caused to penetrate into the electrode body, prior to accommodating the electrode body in the exterior body. Accordingly, the amount of the electrolytic solution to be supplied to an interior of the exterior body is less than the total amount of the electrolytic solution used for the impregnation of the electrode body. As a result, it is possible to shorten a time required for the electrolytic solution to permeate into the electrode body inside the exterior body. Furthermore, since the electrolytic solution is retained at the substance that is capable of retaining an electrolytic solution, it is possible to cause the electrolytic solution to permeate into the electrode body while suppressing volatilization of a solvent.

Respective steps of the method of the present disclosure will be explained below.

### (First Step)

In the first step, an electrode body including a substance that is capable of retaining an electrolytic solution and an electrolytic solution that is retained at the substance is prepared.

In the present disclosure, an electrode body refers to a structure including a laminated body composed of a positive electrode, a negative electrode, and a separator disposed between the positive electrode and the negative electrode.

Examples of a form of the electrode body including the laminated body composed of the positive electrode, the negative electrode, and the separator disposed between the positive electrode and the negative electrode include a state in which plural sheets of laminated bodies that have been cut to predetermined dimensions are overlapped, a state in which an elongated laminated body is wound, and the like.

Hereinafter, the positive electrode and the negative electrode included in the electrode body may be collectively referred to as an “electrode” in some cases.

The type of the substance that is capable of retaining an electrolytic solution is not particularly limited so long as it does not affect battery performances.

The substance that is capable of retaining an electrolytic solution may be a polymer. The type of the polymer is not particularly limited, and examples thereof include polyvinylidene fluoride, polyhexafluoropropylene, polytetrafluoroethylene, polyacrylonitrile, styrene-butadiene rubber, acrylic resin, and polyester resin.

The substance that is capable of retaining an electrolytic solution may have, for example, a configuration in which an electrolytic solution is retained at an interior of a three-dimensional mesh-shaped structure and gelled; a sponge-like configuration; a fibrous configuration; or the like.

From a viewpoint of securing a sufficient degree of energy density of the battery, it is preferable that the substance that is capable of retaining an electrolytic solution has a large retention amount per unit volume with respect to the electrolytic solution. Furthermore, from a viewpoint of operability when preparing the electrode body, it is preferable that the electrolytic solution is less likely to exude from the substance that is capable of retaining an electrolytic solution.

Accordingly, the substance that is capable of retaining an electrolytic solution preferably has a configuration in which the electrolytic solution is retained at an interior of a three-dimensional mesh-shaped structure and gelled. That is to say, it is preferable that the substance that is capable of retaining an electrolytic solution and the electrolytic solution are in a gel state.

The type of the electrolytic solution that is retained at the substance that is capable of retaining an electrolytic solution is not particularly limited, and any product prepared by dissolving a solute that is used in a known electrolytic solution in a solvent may be used.

Specific examples of the solute of the electrolytic solution include LiPF₆, LiFSi and the like.

The solute of the electrolytic solution may be one kind alone, or may be two or more kinds thereof.

Specific examples of the solvent of the electrolytic solution include cyclic or chain carbonates such as ethylene carbonate (EC), dimethyl carbonate (DMC), diethyl carbonate (DEC), ethyl methyl carbonate (EMC) and the like. The solvent may be a mixture of two or more types of solvents, and may be a mixture containing a cyclic carbonate and a chain carbonate.

The solvent may contain an additive such as vinylene carbonate (VC) or the like.

The amount of the substance that is capable of retaining an electrolytic solution to be included in the electrode body is not particularly limited.

From a viewpoint of reducing an amount of the electrolytic solution to be supplied to the interior of the exterior body in the third step, the substance may be included in the electrode at an amount capable of retaining 5% by volume or more, 10% by volume or more, or 15% by volume or more of the total amount of the electrolytic solution used for the impregnation of the electrode body.

From a viewpoint of operability when accommodating the electrode body in the exterior body in the second step, the substance may be included in the electrode body at an amount capable of retaining 80% by volume or less, 50% by volume or less, or 30% by volume or less of the total amount of the electrolytic solution used for the impregnation of the electrode body.

The amount of the electrolytic solution included in the electrode body is not particularly limited.

From the viewpoint of reducing the amount of the electrolytic solution to be supplied to the interior of the exterior body in the third step, the amount of the electrolytic solution included in the electrode body may be 5% by volume or more, 10% by volume or more, or 15% by volume or more of the total amount of the electrolytic solution used for the impregnation of the electrode body.

From the viewpoint of operability when accommodating the electrode body in the exterior body in the second step, the amount of the electrolytic solution included in the electrode body may be 80% by volume or less, 50% by volume or less, or 30% by volume or less of the total amount of the electrolytic solution used for the impregnation of the electrode body.

Examples of a method for preparing the electrode body that includes the substance that is capable of retaining an electrolytic solution and the electrolytic solution that is retained at the substance include Method 1 and Method 2 described below.

Method 1: a method of contacting an electrolytic solution with at least one of an electrode or a separator, which includes the substance that is capable of retaining an electrolytic solution, and subsequently preparing an electrode body using the at least one of the electrode or the separator that has been contacted with the electrolytic solution

Method 2: a method of preparing an electrode body using at least one of an electrode or a separator, which includes a substance that is capable of retaining an electrolytic solution, and subsequently contacting an electrolytic solution with the electrode body

Among Method 1 and Method 2, Method 1 is preferable from a viewpoint of increasing the opportunities for contact between a substance that is capable of retaining an electrolytic solution and an electrolytic solution, thereby enhancing the efficiency of a process of including an electrolytic solution into the electrode body.

The method for contacting the substance that is capable of retaining an electrolytic solution with the electrolytic solution is not particularly limited, and examples thereof include a dipping method, a coating method, and a spraying method.

A method for preparing the electrode body in Method 1 and Method 2 is not particularly limited, and may be carried out by a known method.

When at least one of the electrode or the separator constituting the electrode body includes a substance that is capable of retaining an electrolytic solution, it is possible that all of the at least one of the electrode or the separator include a substance that is capable of retaining an electrolytic solution, or it is possible that some of the at least one of the electrode or the separator may include a substance that is capable of retaining an electrolytic solution.

When at least one of the electrode or the separator constituting the electrode body includes a substance that is capable of retaining an electrolytic solution, the substance may be disposed at a surface of at least one of the electrode or the separator, or may be disposed at an interior of at least one of the electrode or the separator.

For example, the substance that is capable of retaining an electrolytic solution, which is included in at least one of the electrode or the separator, may be in a state of particles disposed at a surface or an interior of at least one of the electrode or the separator, or may be in a state of a layer disposed at a surface or an interior of at least one of the electrode or the separator.

The positive electrode and the negative electrode that are included in the electrode body respectively include a positive electrode active material or a negative electrode active material as an electrode active material.

Specific examples of a positive electrode active material in a case in which the battery is a lithium-ion secondary battery include composite oxides formed of lithium and a transition metal, and optionally other metals (hereinafter, also referred to as lithium transition metal composite oxides). Examples of the transition metal and other metals include Ni, Co, Mn, Al, B, Mg, Ti, V, Cr, Fe, Cu, Zn, Ga, Sr, Zr, Nb, In, Sn, Ta, W, and the like.

Examples of the lithium transition metal composite oxide include layered lithium transition metal composite oxides, spinel-type lithium transition metal composite oxides, olivine-type lithium transition metal composite oxides, and the like.

Examples of the layered lithium transition metal composite oxide include those containing at least one selected from Ni, Co, or Mn as the transition metal. Specific examples thereof include compounds represented by a structural formula of LiNiₐCo_{b}Mn_{c}O₂ (in which each of a, b, and c is a number of 0 or more and 1 or less, and a+b+c=1), and compounds in which one or more elements selected from Al, Mg, La, Ti, Zn, B, W, Fe, Cr, V, Ru, Cu, Cd, Ag, Y, Sc, Ga, In, As, Sb, Pt, Au, Si, or the like are added to the aforementioned compounds.

Specific examples of the spinel-type lithium transition metal composite oxide include LiMn₂O₄.

Specific examples of the olivine-type lithium transition metal composite oxide include LiMPO₄ (in which M is Fe, Co, Ni or Mn).

The positive electrode active material contained in the electrode may be one kind alone, or may be two or more kinds thereof.

Specific examples of a negative electrode active material in a case in which the battery is a lithium-ion secondary battery include carbon materials such as graphite, hard carbon, soft carbon, activated carbon and the like, silicon, metallic lithium, lithium alloys, lithium titanate (LTO) and the like.

The negative electrode active material contained in the electrode may be one kind alone, or may be two or more kinds thereof.

The electrode may contain a conductive material.

Specific examples of the conductive material include carbon materials such as carbon black (acetylene black, thermal black, furnace black, or the like), carbon nanotubes, graphite, and the like.

The conductive material contained in the electrode may be one kind alone, or may be two or more kinds thereof.

The electrode may contain a binder.

Specific examples of the binder include polyvinylidene fluoride (PVdF), polyethylene, polypropylene, polyethylene terephthalate, cellulose, nitrocellulose, carboxymethylcellulose, polyethylene oxide, polyepichlorohydrin, polyacrylonitrile, styrene-butadiene rubber (SBR), acrylonitrile-butadiene rubber (NBR), polyacrylate, polymethacrylate, polytetrafluoroethylene (PTFE), and the like.

The binder contained in the electrode may be one kind alone, or may be two or more kinds thereof.

The electrode included in the electrode body may include a current collector and an electrode layer arranged so as to contact one surface or both surfaces of the current collector.

A thickness of the electrode layer is not particularly limited, and can be selected from general thicknesses of electrode layers. For example, the thickness of the electrode layer can be selected from a range of from 10 μm to 200 μm.

Examples of a material configuring a current collector of the positive electrode include aluminum, aluminum alloys, nickel, titanium, stainless steel, and the like. Examples of a shape of the current collector include a foil, a mesh, and the like.

Examples of a material configuring a current collector of the negative electrode include copper, copper alloys, nickel, titanium, stainless steel, and the like. Examples of a shape of the current collector include a foil, a mesh, and the like.

Examples of the separator included in the electrode body include nonwoven fabrics, cloths, microporous films and the like, containing a polyolefin such as polyethylene, polypropylene or the like, as a main component.

The thickness of the separator is not particularly limited, and may be selected from general thicknesses of separators. For example, the thickness of the separator may be selected from a range of from 10 μm to 200 μm.

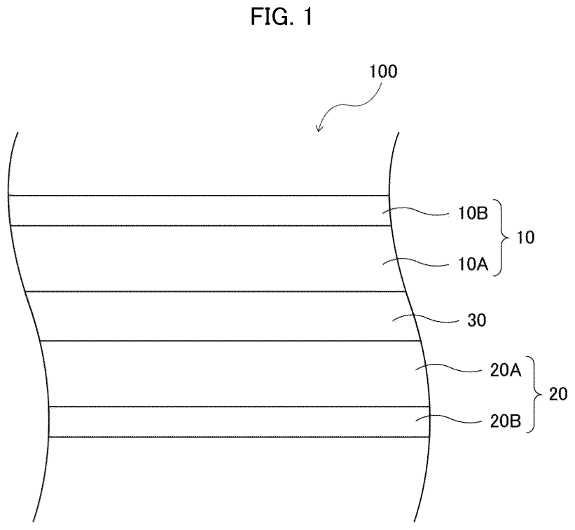

An example of a configuration of the laminated body included in the electrode body is schematically illustrated in FIG. 1.

A laminated body 100 illustrated in FIG. 1 includes a positive electrode 10, a negative electrode 20, and a separator 30 arranged between the positive electrode 10 and the negative electrode 20. The positive electrode 10 includes a positive electrode layer 10A and a positive electrode current collector 10B. The negative electrode 20 includes a negative electrode layer 20A and a negative electrode current collector 20B.

### (Second Step)

In the second step, the electrode body that includes the substance that is capable of retaining an electrolytic solution and the electrolytic solution that is retained at the substance is accommodated in the exterior body.

The type of the exterior body in which the electrode body is accommodated is not particularly limited, and may be selected according to the type of the battery.

In certain exemplary embodiments, a sheet-shaped exterior body may be used.

Examples of the sheet-shaped exterior body include those containing a metal. Specific examples include laminated bodies (so-called laminate films) having a metal layer containing a metal such as aluminum or the like, and a heat seal layer containing a resin that is melted by heating. That is to say, the battery manufactured by the method of the present disclosure may be a battery (so-called laminate battery) in which a laminate film is used as the exterior body.

The exterior body may be a single member, or may be composed of two or more members. For example, in a case in which the exterior body is a sheet-shaped object, the exterior body may be composed of one sheet-shaped object, or may be composed of two sheet-shaped objects.

If necessary, a recess for accommodating the electrode body may be formed in the sheet-shaped exterior body by embossing.

Examples of a method for accommodating the electrode body in the exterior body using a sheet-shaped exterior body include, for example, the following Method 1 and Method 2.

Method 1: a method of, in a state in which the electrode body is arranged between one exterior body that has been folded in half or between two exterior bodies that have been superposed, joining the exterior body (or bodies) at a periphery of the electrode body

Method 2: a method of inserting the electrode body into a bag that has been prepared by joining a periphery of one exterior body that has been folded in half or two exterior bodies that have been superposed

### (Third Step)

In the third step, the electrolytic solution is supplied to an interior of the exterior body in which the electrode body is accommodated.

A method for supplying the electrolytic solution to the interior of the exterior body is not particularly limited, and may be selected from known methods.

The supplying of the electrolytic solution may include depressurizing the interior of the exterior body accommodating the electrode body. By depressurizing the interior of the exterior body accommodating the electrode body, permeation of the electrolytic solution into the electrode body can be promoted.

In the method of the present disclosure, the electrode body includes the electrolytic solution prior to a process of accommodating the electrode body in the exterior body. Accordingly, the amount of the electrolytic solution that is supplied to an interior of the exterior body in the third step is less than the total amount of the electrolytic solution used for the impregnation of the electrode body. As a result, it is possible to shorten the time required for the electrolytic solution to penetrate into the electrode body in the third step.

### (Types of the Battery and Application Examples)

The type of battery manufactured by the method of the present disclosure is not particularly limited.

Specific examples of the battery include secondary batteries such as lithium-ion secondary batteries, lead storage batteries, nickel-hydrogen storage batteries, nickel-cadmium storage batteries, nickel-iron storage batteries, nickel-zinc storage batteries, silver oxide-zinc storage batteries, cobalt-titanium-lithium secondary batteries, and the like.

From the viewpoints of energy density, versatility, and the like, the battery may be a lithium-ion secondary battery.

The battery manufactured by the method of the present disclosure may be mounted at an electric vehicle. An example in which the battery is applied to an electric vehicle will be explained below with reference to the drawings. In the following explanation, a “battery cell 20” corresponds to the battery of the present disclosure.

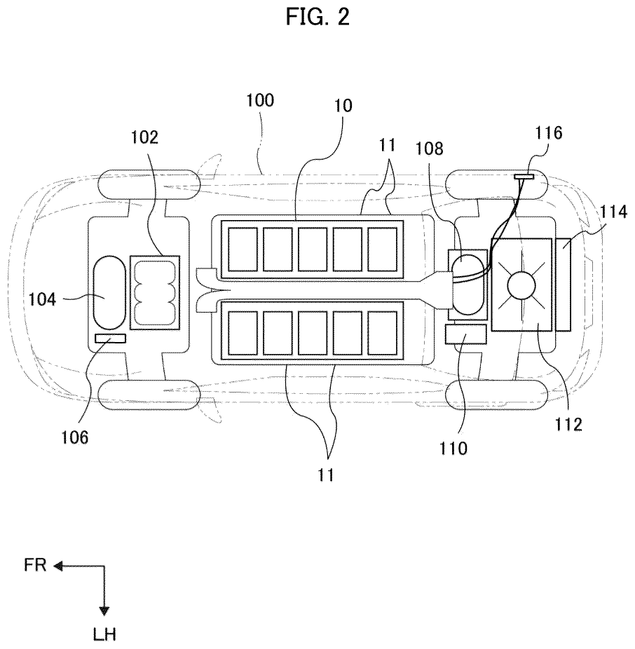

FIG. 2 is a schematic plan view illustrating a main part of a vehicle 100 to which a battery pack 10 according to an exemplary embodiment has been applied. As shown in FIG. 2, the vehicle 100 is an electric vehicle (battery electric vehicle (BEV)) at which the battery pack 10 is mounted under a floor. It should be noted that arrow UP, arrow FR, and arrow LH in the respective drawings respectively indicate an upper side in a vehicle up-down direction, a front side in a vehicle front-rear direction, and a left side in a vehicle width direction. In cases in which explanation is given using front-rear, left-right, and up-down directions, unless otherwise specified, these indicate front and rear in the vehicle front-rear direction, left and right in the vehicle width direction, and up and down in the vehicle up-down direction.

As an example, in the vehicle 100 of the present exemplary embodiment, a DC/DC converter 102, an electric compressor 104, and a positive temperature coefficient (PTC) heater 106 are arranged further toward a vehicle front side than the battery pack 10. Further, a motor 108, a gear box 110, an inverter 112, and a charger 114 are arranged further toward a vehicle rear side than the battery pack 10.

A DC current that has been output from the battery pack 10 is adjusted in voltage by the DC/DC converter 102, and thereafter supplied to the electric compressor 104, the PTC heater 106, the inverter 112, and the like. Furthermore, due to electric power being supplied to the motor 108 via the inverter 112, rear wheels rotate to drive the vehicle 100.

A charging port 116 is provided at a right side portion of a rear portion of the vehicle 100, and by connecting a charging plug of an external charging facility, which is not illustrated in the drawings, from the charging port 116, electric power can be stored in the battery pack 10 via the vehicle-mounted charger 114.

An arrangement, structure and the like of the respective components configuring the vehicle 100 are not limited to the configuration described above. For example, the present disclosure may be applied to vehicles installed with an engine such as hybrid vehicles (HV) and plug-in hybrid electric vehicles (PHEV). Further, in the present exemplary embodiment, although the vehicle is configured as a rear-wheel drive vehicle in which the motor 108 is mounted at the rear portion of the vehicle, there is no limitation thereto; the vehicle may be configured as a front-wheel drive vehicle in which the motor 108 is mounted at the front portion of the vehicle, and a pair of motors 108 may also be mounted at the front and rear of the vehicle. Furthermore, the vehicle may also be provided with in-wheel motors at the respective wheels.

The battery pack 10 is configured to include plural battery modules 11. In the present exemplary embodiment, as an example, ten battery modules 11 are provided. Specifically, five battery modules 11 are arranged in the vehicle front-rear direction at the right side of the vehicle 100, and five battery modules 11 are arranged in the vehicle front-rear direction at the left side of the vehicle 100. Furthermore, each of the battery modules 11 are electrically connected to each other.

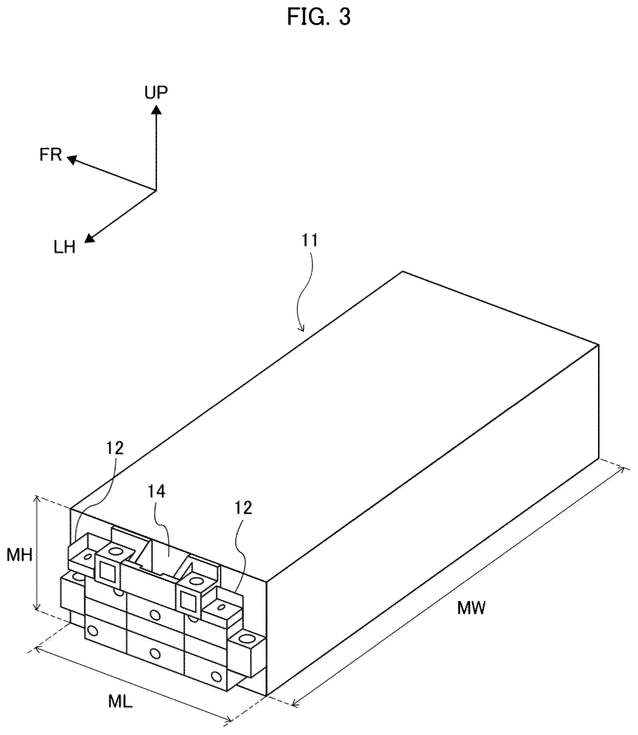

FIG. 3 is a schematic perspective view of a battery module 11. As shown in FIG. 3, the battery module 11 is formed in a substantially rectangular parallelepiped shape having a longitudinal direction along the vehicle width direction. Furthermore, an outer shell of the battery module 11 is formed of an aluminum alloy. For example, the outer shell of the battery module 11 is formed by joining aluminum die-casting to both ends of an extruded material of an aluminum alloy by laser welding or the like.

A pair of voltage terminals 12 and a connector 14 are provided at both vehicle width direction end portions of the battery module 11. A flexible printed circuit board 21, which will be described later, is connected to the connector 14. Furthermore, bus bars, which are not illustrated in the drawings, are welded to both vehicle width direction end portions of the battery module 11.

A length MW of the battery module 11 in the vehicle width direction is, for example, from 350 mm to 600 mm, a length ML thereof in the vehicle front-rear direction is, for example, from 150 mm to 250 mm, and a height MH thereof in the vehicle up-down direction is, for example, from 80 mm to 110 mm.

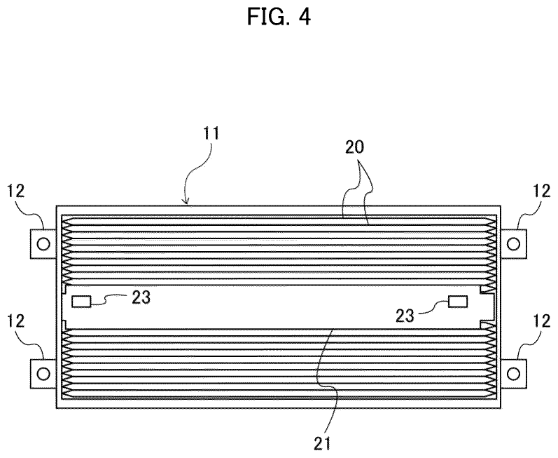

FIG. 4 is a plan view of the battery module 11 in a state in which an upper lid thereof has been removed. As shown in FIG. 4, plural battery cells 20 are accommodated at an interior of the battery module 11 in an arranged state. In the present exemplary embodiment, as an example, twenty-four battery cells 20 are arranged in the vehicle front-rear direction and are adhered to each other.

A flexible printed circuit (FPC) board 21 is arranged on the battery cells 20. The flexible printed circuit board 21 is formed in a band shape with a longitudinal direction thereof along the vehicle width direction, and thermistors 23 are respectively provided at both end portions of the flexible printed circuit board 21. The thermistors 23 are not adhered to the battery cells 20 and are configured to be pressed toward the battery cells 20 side by the upper lid of the battery module 11.

Furthermore, one or more cushioning materials, which are not illustrated in the drawings, are accommodated at the interior of the battery module 11. For example, the cushioning material is a thin plate-shaped member that is elastically deformable, and is arranged between adjacent battery cells 20 with a thickness direction thereof along an arrangement direction of the battery cells 20. In the present exemplary embodiment, as an example, cushioning materials are respectively arranged at both longitudinal direction end portions of the battery module 11 and at a longitudinal direction central portion thereof.

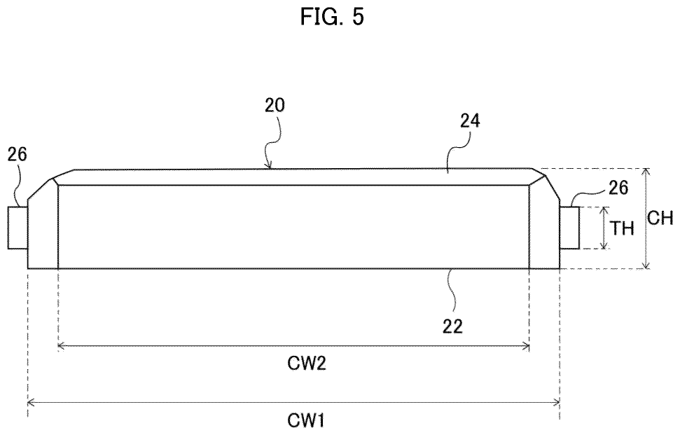

FIG. 5 is a schematic diagram in which a battery cell 20 that is accommodated in the battery module 11 is viewed from a thickness direction thereof. As shown in FIG. 5, the battery cell 20 is formed in a substantially rectangular plate shape, and an electrode body, which is not shown in the drawings, is accommodated at an interior thereof. The electrode body is configured by laminating a positive electrode, a negative electrode, and a separator, and is sealed by a laminate film 22.

In the present embodiment, as an example, the embossed, sheet-shaped laminate film 22 is folded and bonded to thereby form a housing portion of the electrode body. The laminate film 22 may have either a single-cup embossing structure in which embossing is at one place or a double-cup embossing structure in which embossing is at two places. In an embodiment, the laminate film 22 has a single-cup embossing structure with a draw depth of from about 8 mm to 10 mm.

Upper ends of both longitudinal direction end portions of the battery cell 20 are folded over, and corners thereof form an outer shape. Furthermore, an upper end portion of the battery cell 20 is folded over, and a fixing tape 24 is wound around the upper end portion of the battery cell 20 along the longitudinal direction.

Terminals (tabs) 26 are respectively provided at both ends in the longitudinal direction of the battery cell 20. In the present embodiment, as an example, the terminals 26 are provided at positions that are offset downward from the center of the battery cell 20 in the up-down direction. The terminals 26 are connected to the bus bars, which are not illustrated in the drawings, by laser welding or the like.

For example, the battery cell 20 has a length CW1 in the vehicle width direction of from 530 mm to 600 mm, from 600 mm to 700 mm, from 700 mm to 800 mm, from 800 mm to 900 mm, or greater than or equal to 1000 mm; a length CW2 of the region in which the electrode body is housed of from 500 mm to 520 mm, from 600 mm to 700 mm, from 700 mm to 800 mm, from 800 to 900 mm, or greater than or equal to 1000 mm; a height CH of from 80 mm to 110 mm or from 110 mm to 140 mm; a thickness of from 5.0 mm to 7.0 mm, from 7.0 mm to 9.0 mm, or from 9.0 mm to 11.0 mm; and a height TH of the terminal 26 of from 40 mm to 50 mm, from 50 mm to 60 mm, or from 60 mm to 70 mm.

All publications, patent applications, and technical standards mentioned in the present specification are incorporated herein by reference to the same extent as if each individual publication, patent application, or technical standard was specifically and individually indicated to be incorporated by reference.

What is claimed is:

1. A method for manufacturing a battery, the method comprising:
a first step of preparing an electrode body including a substance that is capable of retaining an electrolytic solution and an electrolytic solution that is retained at the substance;
a second step of accommodating the electrode body in an exterior body; and
a third step of supplying an electrolytic solution to an interior of the exterior body.

2. The method for manufacturing a battery according to claim 1, wherein the substance that is capable of retaining an electrolytic solution is a polymer.

3. The method for manufacturing a battery according to claim 1, wherein the substance that is capable of retaining an electrolytic solution and the electrolytic solution are in a gel state.

4. The method for manufacturing a battery according to claim 1, wherein a method for preparing the electrode body in the first step is a method of contacting the electrolytic solution with at least one of an electrode or a separator that includes the substance that is capable of retaining an electrolytic solution, and subsequently preparing the electrode body using the at least one of the electrode or the separator that has been contacted with the electrolytic solution.

5. The method for manufacturing a battery according to claim 1, wherein a method for preparing the electrode body in the first step is a method of preparing the electrode body using at least one of an electrode or a separator that includes the substance that is capable of retaining an electrolytic solution, and subsequently contacting the electrolytic solution with the electrode body.
